(19) United States
(12) Patent Application Publication
(10) Pub. No.: US 2017/0286382 A1
(43) Pub. Date: Oct. 5, 2017

(54) PERSISTING ANNOTATIONS APPLIED TO AN ELECTRONIC HOSTED WHITEBOARD

(71) Applicant: International Business Machines Corporation, Armonk, NY (US)

(72) Inventors: Jonathan Dunne, Dungarvan (IE); James P. Galvin, JR., Georgetown, KY (US); Liam Harpur, Skerries (IE); Amy D. Travis, Arlington, MA (US)

(21) Appl. No.: 15/088,502

(22) Filed: Apr. 1, 2016

(51) Int. Cl. G06F 17/24; G06F 3/14; G06F 17/27

(52) U.S. Cl. CPC G06F 17/241; G06F 17/27; G06F 3/1454

(57) ABSTRACT

A plurality of annotations can be received for a presentation presented in a web conference. For each of the plurality of annotations, a respective portion of the presentation to which the annotation pertains can be determined, and a respective relevance parameter can be assigned to the annotation. The relevance parameter can indicate a relevance of the annotation to the respective portion of the presentation to which the annotation pertains. For each of the plurality of annotations, the annotation can be assigned to a respective location of a view based on the relevance parameter assigned to the annotation and the annotation can be presented in the respective location of the view to which the annotation is assigned.

### BACKGROUND

The present invention relates to web conferencing, and more specifically, to presentations presented in a web conference.

Web conferencing is a popular means of collaboration among people. By leveraging use of a virtual white board, which is real time collaboration tool that may be hosted in a web conference, a presenter can convey visual information to an audience, for example text, images, etc. In addition, the presenter and/or other people collaborating in the web conference can add annotations to the virtual white board to share those annotations with other participants of the web conference. Thus, using a web conference with a hosted virtual white board, participants no longer need to all be present in the same physical meeting room in order to collaborate and share visual information.

### SUMMARY

A system includes a processor programmed to initiate executable operations. The executable operations include receiving a plurality of annotations for a presentation presented in a web conference. The executable operations also can include, for each of the plurality of annotations, determining a respective portion of the presentation to which the annotation pertains, and assigning to the annotation a respective relevance parameter, wherein the relevance parameter indicates a relevance of the annotation to the respective portion of the presentation to which the annotation pertains. The executable operations also can include, for each of the plurality of annotations, assigning the annotation to a respective location of a view based on the relevance parameter assigned to the annotation and presenting the annotation in the respective location of the view to which the annotation is assigned.

A computer program includes a computer readable storage medium having program code stored thereon. The program code is executable by a processor to perform a method. The method includes receiving, by the processor, a plurality of annotations for a presentation presented in a web conference. The method also can include, for each of the plurality of annotations, determining, by the processor, a respective portion of the presentation to which the annotation pertains, and assigning, by the processor, to the annotation a respective relevance parameter, wherein the relevance parameter indicates a relevance of the annotation to the respective portion of the presentation to which the annotation pertains. The method also can include, for each of the plurality of annotations, assigning, by the processor, the annotation to a respective location of a view based on the relevance parameter assigned to the annotation and presenting, by the processor, the annotation in the respective location of the view to which the annotation is assigned.

### BRIEF DESCRIPTION OF THE DRAWINGS

FIG. 1 is a block diagram illustrating an example of a network computing environment.

FIG. 2 depicts an example view of a virtual white board in which a presentation is presented during a web conference.

FIG. 3 depicts a data table in which annotations are associated with portions content of a presentation and assigned respective relevance parameters.

FIG. 4 depicts another example view of a virtual white board in which a presentation is presented during a web conference.

FIG. 5 is a flow chart illustrating an example of a method of presenting a plurality of annotations in respective locations of a view to which the annotations are assigned.

FIG. 6 is a block diagram illustrating example architecture for a server configured to host a web conference.

FIG. 7 is a block diagram illustrating example architecture for a client device.

### DETAILED DESCRIPTION

The present invention relates to web conferencing, and more specifically, to presentations presented in a web conference.

In accordance with the inventive arrangements disclosed herein, a presentation can be presented to a plurality of participants participating in a web conference. One or more participants in the web conference can contribute annotations to the presentation, and a system hosting the web conference can receive the annotations. The system can assign to each annotation a respective relevance parameter. Each relevance parameter can indicate a relevance of a respective annotation to a portion of the presentation to which the annotation pertains. The system can, for each annotation, assign the annotation to a respective location of a view based on the relevance parameter assigned to the annotation. The system can present the annotation in the respective location of the view to which the annotation is assigned.

Several definitions that apply throughout this document now will be presented.

As defined herein, the term “web conference” means a real time communication session in which a plurality of participants are displayed the same view (e.g., a virtual white board) on their client devices and in which two or more of the plurality of participants may contribute annotations to a presentation presented in the displayed view.

As defined herein, the term “presentation” means text, images, video, audio and/or the like presented in a web conference.

As defined herein, the term “virtual white board” means an interactive view, configured to be presented on at least one display, hosted in a web conference in which a presentation is presented and in which two or more participants of the web conference may provide, in real time, annotations related to the presentation.

As defined herein, the term “annotation” means text contributed by a participant in a web conference to a presentation presented in the web conference. An annotation may contribute additional material to the presentation, provide comments on the presentation, ask questions regarding the presentation, or the like.

As defined herein, the term “parent content” means a portion of content of a presentation to which an annotation pertains.

As defined herein, the term “relevance parameter” means a value assigned to an annotation that indicates a relevance of the annotation to a portion of a presentation to which the annotation pertains.

As defined herein, the term “clear space” means an area of a presentation where content (e.g., text, images, etc.) is not located.

As defined herein, the term “client device” means a processing system including at least one processor and memory that requests shared services from a server, and with which a user directly interacts. Examples of a client device include, but are not limited to, a workstation, a desktop computer, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “server” means at least one processing system including at least one processor and memory that hosts shared services and provides the shared services to a plurality of client devices.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “proximate” means immediately above, immediately below or immediately next to.

As defined herein, the term “automatically” means without user intervention.

As defined herein, the term “participant” means a person (i.e., a human being) participating in a web conference.

As defined herein, the term “presenter” means a person (i.e., a human being) that presents in a presentation in a web conference.

As defined herein, the term “user” means a person (i.e., a human being). A user may be a participant in a web conference, or a user who is not a participant in the web conference but who later views the web conference.

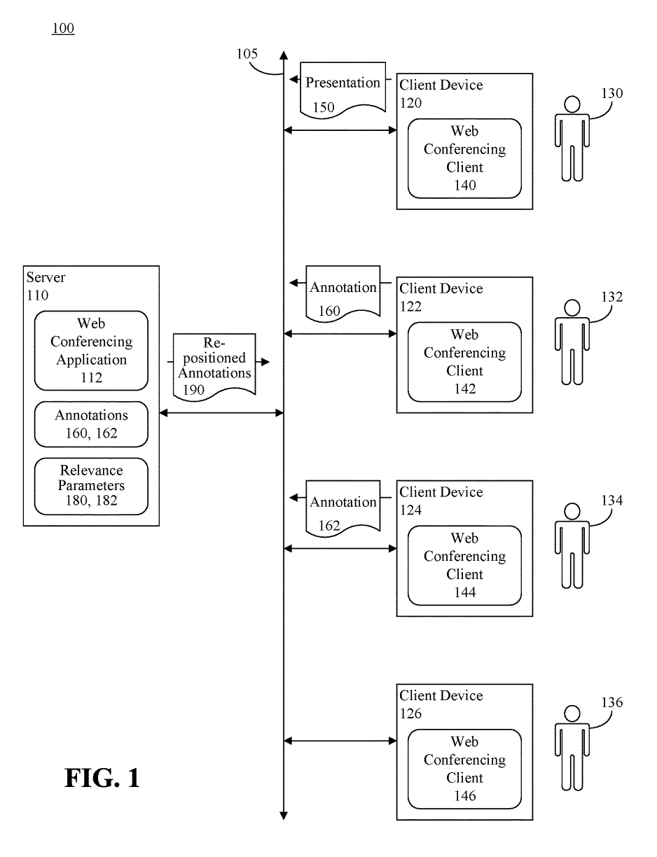

FIG. 1 is a block diagram illustrating an example of a network computing environment 100. The network computing environment 100 can include a server 110 and a plurality of client devices 120, 122, 124, 126. The client devices 120-126 can be communicatively linked to the server 110 via a communication network 105. The communication network 105 is the medium used to provide communications links between various devices and data processing systems connected together within the network computing environment 100. The communication network 105 may include connections, such as wire, wireless communication links, or fiber optic cables. The communication network 105 can be implemented as, or include, any of a variety of different communication technologies such as a local area network (LAN), a wide area network (WAN), a wireless network, a mobile network, a Virtual Private Network (VPN), the Internet, the Public Switched Telephone Network (PSTN), or the like.

The server 110 can execute a web conferencing application 112 configured to host a web conference in which participants 130, 132, 134, 136 participate using client devices 120-126. In this regard, each client device 120-126 can execute a respective web conferencing client 140, 142, 144, 146 via which the participants 130-136 participate in the web conference. The web conferencing clients 140-146 can be web browsers or other applications specifically configured for web conferencing.

At least one participant, for example the participant 130, can provide a presentation 150 in the web conference that is presented to each of the participants 130-136. For example, the participant 130 can use the web conferencing client 140 to provide the presentation 150 on a virtual white board hosted by the web conferencing application 112. The web conferencing application 112 also can present virtual white board, with the presentation 150, to the other participants 132-136.

While the presentation 150 is presented, one or more participants 130-136 can provide annotations to the presentation 150 by interacting with their respective web conferencing clients 140-146. For example, via the web conferencing client 142, the participant 132 can provide the annotation 160 on the virtual white board or in another view hosted by the web conferencing application 112. The participant 134 also can generate an annotation 162 in a similar manner using the web conferencing client 144.

In response to receiving each annotation 160, 162 from a respective web conferencing client 140-146, the web conferencing application 112 can store the annotation 160, 162 to a computer readable storage medium in a manner that associates the annotation 160, 162 with the presentation 150 and the particular portion of the presentation (e.g., page, slide, etc.) for which the annotation is generated. For instance, the web conferencing application 112 can store the annotations 160, 162 to a database contained on the computer readable storage medium. The web conferencing application 112 also can present the annotations 160, 162 to one or more of the participants 130-136, for example by presenting the annotations 160, 162 on the virtual white board on which the portion of the presentation 150 to which the annotation 160, 162 pertains is presented, or by presenting the annotations 160, 162 in another manner.

For each annotation 160, 162, the web conferencing application 112 can process the content of the annotation 160, 162 and the content of the presentation 150 to automatically determine to which portion of the presentation 150 the annotation 160, 162 pertains. In illustration, if an annotation 160 is added to the virtual white board while a particular slide is being presented, the web conferencing application can process the annotation 160 and content presented on that slide to determine to which portion of the content the annotation 160 pertains. The determined portion can be identified as parent content for the annotation 160. The web conferencing application 112 make the determination using natural language processing (NLP) and semantic analysis.

Further, the web conferencing application 112 can automatically determine a level of correlation between the annotation 160 and the parent content to which the annotation 160 pertains. In illustration, the web conferencing application 112 can apply regression analysis on results of the NLP and semantic analysis generated by comparing the annotation 160 to the parent content. The web conferencing application 112 can calculate a relevance parameter 180 based on such level of correlation. The web conferencing application also can determine parent content to which the annotation 162 pertains, and calculate a corresponding relevance parameter 182 for the annotation 162 in a similar manner.

The higher the level of correlation between the annotation 160 and parent content to which the annotation 160 applies, the higher the relevance parameter 180 will be. Conversely, the lower the level of correlation between the annotation 160 and the parent content, the lower the relevance parameter 180 will be. By way of example, if the parent content to which the annotation 160 pertains includes text pertaining to fitting a curve to data points, and the annotation 160 includes text asking about distances between a data point and the curve, the relevance parameter assigned to annotation 160 can be relatively high (e.g., closer to a value of 1 than to 0). On the other hand, if the annotation 160 includes text in the nature of “I am having difficulty understanding this concept,” the relevance parameter assigned to annotation 160 can be relatively low (e.g., closer to a value of 0 than to 1). Based on the respective relevance parameters 180, 182, the web conferencing application 112 can determine where on virtual white board the annotations 160, 162 are to be presented based on the respective relevance parameters 180, 182, and present the annotations 160, 162 on the virtual white board in those locations, for example as re-positioned annotations 190.

At this point it should be noted that NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the web conferencing application 112 to implement NLP and semantic analysis. Regression analysis also is known to those of ordinary skill in the art. Various types of regression analysis that may be used in the present arrangements include to determine the relevance parameters 180, 182 include, but are not limited to, statistical regression, linear regression, parametric regression, Poisson regression, logistic regression, generalized regression, and the like.

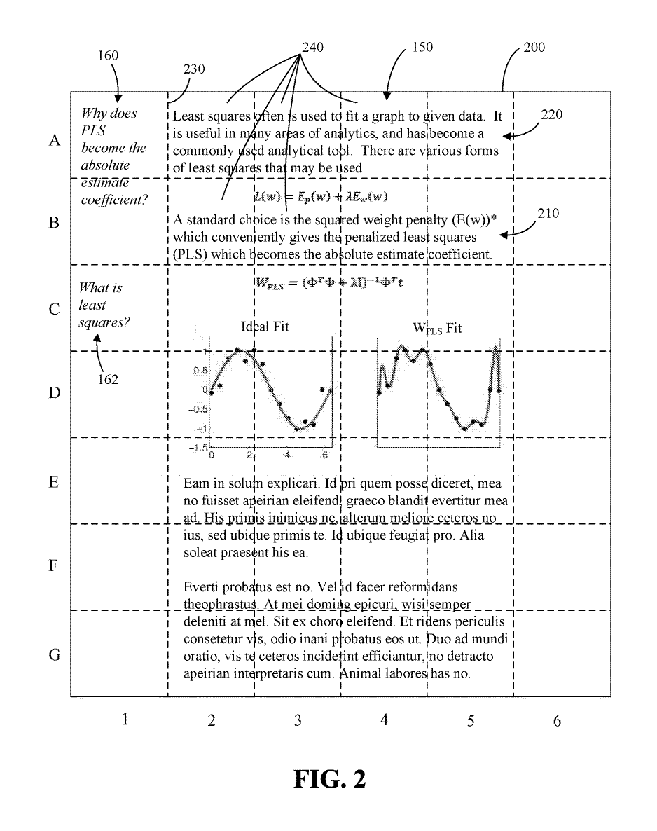

FIG. 2 depicts an example view of a virtual white board 200 in which a presentation 150 is presented during a web conference. The view of the virtual white board 200 can be presented on displays of the respective client devices 120-136 by the respective web conferencing clients 140-146. The web conferencing application 112 can define a grid 230 for the virtual white board 200 and assign coordinates to different cells (i.e., regions) 240 of the virtual white board 200 defined by the grid 230. In illustration, the web conferencing application 112 can define rows A, B, C, D, E, F, G and columns 1, 2, 3, 4, 5, 6 of cells 240 for the grid 230, similar to a Cartesian coordinate system. Thus, each cell 240 of the virtual white board 200 can be identified by a particular row and column. The grid 230, row identifiers A-G and column identifiers 1-6 need not be visible on the displays of the respective client devices 120-126. Nonetheless, the web conferencing application 112 can create an association between each region of the virtual white board 200 and corresponding row and column identifiers. It will be understood that the grid 230 can include any number of rows and columns, depending on a desired granularity, and the present arrangements are not limited in this regard.

As noted, while the presentation 150 is presented in the virtual white board 200, one or more participants 130-136 may provide annotations 160, 162 for the presentation 150. For example, the participant 132 may provide the annotation 160 in cells 240 of the virtual white board 200 defined at row A, column 1 (i.e., cell A1) and row B, column 1 (i.e., cell B1) of the grid 230. Similarly, the participant 134 may provide the annotation 162 in a cell 240 of the virtual white board 200 defined to be at row C, column 1 (i.e., cell C1) of the grid 230.

In one arrangement, the web conferencing application 112 can configure each cell 240 to be user selectable, and a participant 130-136 may select a particular cell 240 of the virtual white board 200 to enter an annotation 160, 162 into that cell 240. If a particular annotation 160 is too large to fit into one cell, the annotation 160 can expand into a proximate cell. In another arrangement, a participant 130-136 can enter an annotation 160, 162 onto the virtual white board 200 wherever the participant 130-136 so chooses.

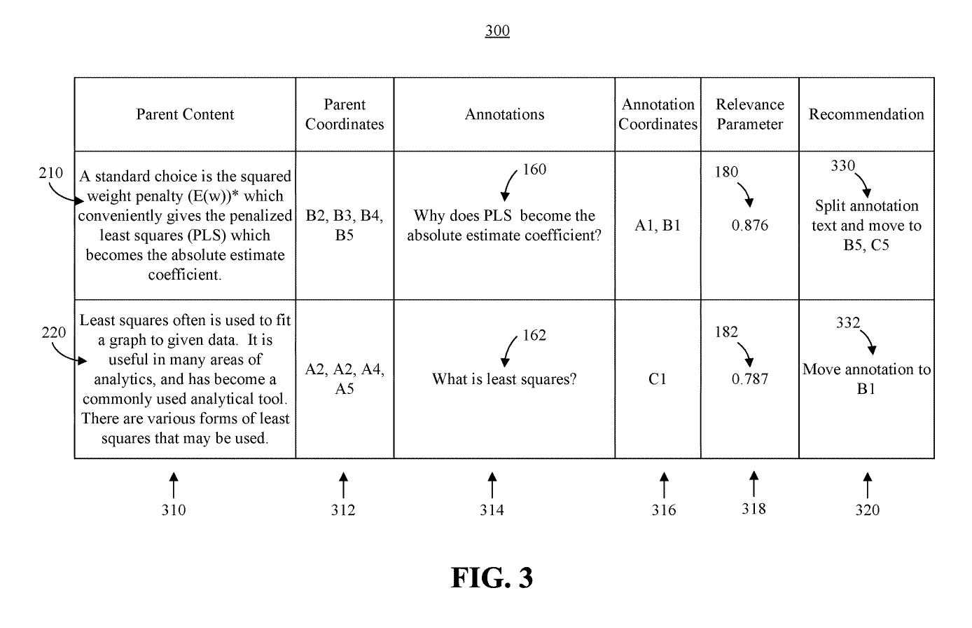

FIG. 3 depicts a data table 300 in which the web conferencing application 112 automatically associates annotations 160, 162 with portions of content of a presentation 150 and assigned respective relevance parameters 180, 182. The data table 300 can be a data table in a database or any other suitable data structure.

The data table 300 can include a column 310 identifying the portions of the presentation 150 to which the respective annotations 160, 162 are determined to pertain. Such portions of the presentation 150 are referred to herein as parent content 210, 220. As noted, the web conferencing application 112 can apply NLP and semantic analysis to the annotations 160, 162 and content of the presentation 150 to identify the parent content 210, 220. In this example, results of the NLP and semantic analysis can indicate that the annotation 160 is more closely related to the parent content 210 than other portions of the presentation 150, and thus the web conferencing application 112 can determine that the annotation 160 pertains to the parent content 210. Similarly, results of the NLP and semantic analysis can indicate that the annotation 162 is more closely related to the parent content 220 than other portions of the presentation 150, and thus the web conferencing application 112 can determine that the annotation 162 pertains to the parent content 220. The data table 300 also can include a column 312 identifying the grid coordinates of the parent content 210, 220. In this example, the parent content 210 is located in cells B2, B3, B4, B5 of the grid 230, and the parent content 220 is located in cells A2, A2, A4, A5 of the grid 230.

The data table 300 also can include a column 314 identifying the annotations 160, 162 added to the virtual white board 200 in which the presentation 150 is presented. The data table 300 can associate the annotations 160, 162 with the respective parent content 210, 220, for example by storing each annotations 160, 162 in the same record as the respective parent content 210, 220. The data table 300 further can include a column 316 identifying the grid coordinates of the respective annotations 160, 162. In this example, the annotation 160 is located in cells Al, B1 of the grid 230, and the annotation 162 is located in cell Cl of the grid 230.

The data table 300 also can include a column 318 indicating the relevance parameter 180, 182 assigned to each of the respective annotations 160, 162. As noted, the web conferencing application 112 can apply regression analysis to results of the NLP and semantic analysis to determine the relevance parameters 180, 182. Based on the relevance parameters 180, 182, the web conferencing application 112 can determine new locations where the annotations 160, 162 are to be presented in the virtual white board 200, and generate corresponding recommendations 330, 332. The web conferencing application 112 can store the recommendations in column 320 of the data table 300.

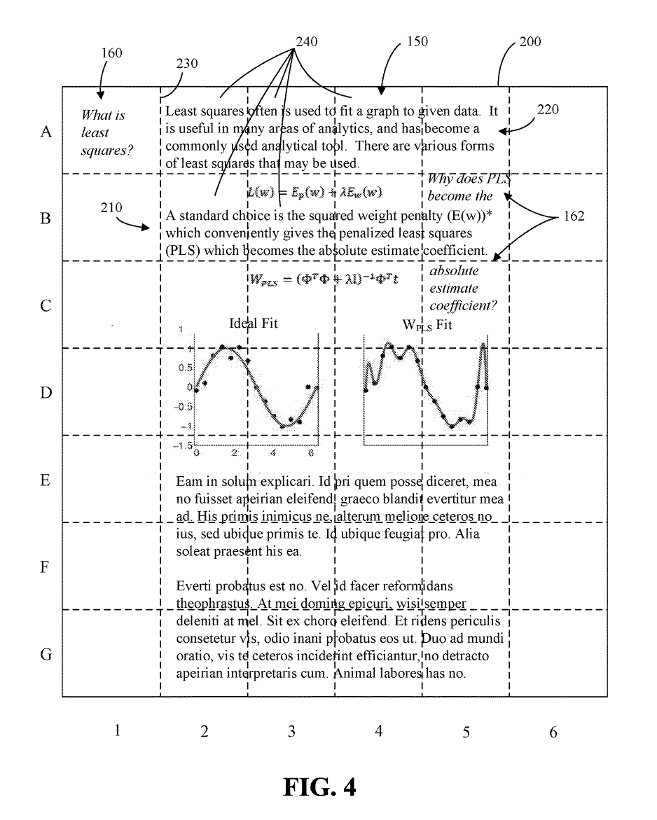

FIG. 4 depicts another example view of the virtual white board 200 of FIG. 2. With regard to FIG. 4, the web conferencing application 112 automatically can assign to the annotations 160, 162 respective locations of the virtual white board 200 where the annotations 160, 162 are presented based on the respective relevance parameters 180, 182, and the web conferencing application 112 can move the annotations 160, 162 to those respective locations. As noted, the view of the virtual white board 200 can be presented by displays of the client devices 120-126. Thus, by assigning the respective locations of the virtual white board 200 to the annotations 160, 162, the web conferencing application 112 automatically assigns to the annotations 160, 162 respective locations of a display.

Referring to FIGS. 3 and 4, the web conferencing application 112 can determine that the relevance parameter 180 assigned to the annotation 160 has a value that is higher than the relevance parameter 182 assigned to the annotation 162. Thus, based on the relevance parameters 180, 182, the web conferencing application 112 can rank the annotation 160 higher than the annotation 162. Because the annotation 160 is ranked higher, the web conferencing application 112 can give the annotation 160 higher priority when determining where to re-locate the annotation 160 in the virtual white board 200. For instance, the web conferencing application 112 can determine one or more cells 240 of grid 230, or portions of one or more cells 240, where the annotation 160 is to be moved, and reserve those cells, or the portions of the cells, exclusively for the annotation 160. Accordingly, those cells 240, or portions thereof, reserved for the annotation 160 can be made to be unavailable for other annotations, such as the annotation 162.

In selecting the cells 240 where the annotation 160 is to be moved, the web conferencing application 112 can determine whether the relevance parameter 180 exceeds a threshold value, (e.g., the relevance parameter 180 exceeds 0.800). If the relevance parameter 180 exceeds the threshold value, the web conferencing application 112 can determine that the annotation 160 should be moved near the parent content 210, for example by placing at least a portion of the annotation 160 as close as practical to the parent content 210 without covering the parent content 210 or other content in the presentation 150.

For example, the web conferencing application 112 can process of the presentation 150 (e.g., the slide of the presentation 150 for which the annotations 160 is provided) to identify space in the presentation 150 where content is not located (i.e., clear space). For instance, the web conferencing application 112 can perform image processing on the presentation (e.g., the slide) to identify the clear space. From the identified clear space, the web conferencing application 112 can identify clear space proximate to (e.g., immediately above, below or next to) the parent content 210, and select that clear space for placement of at least a portion of the annotation 160. The clear space may be contained in one or more cells 240 of the grid 230. In this example, the web conferencing application 112 has identified clear space proximate to the parent content 210 in cells B5, C5. Accordingly, the web conferencing application 112 can select the identified clear space in cells B5, C5 to be the location where the annotation 160 is to be moved from the different location (e.g., cells Al, B1) where the annotation 160 was originally provided, and move the annotation to cells B5, C5.

In some instances, a single region of clear space may not be large enough to contain an entire annotation 160. In such an instance, the web conferencing application 112 can parse the text of the annotation 160, and determine to locate a portion of the parsed text in a one region of clear space, and locate one or more other portions of the parsed text on one or more other regions. In the example shown in FIGS. 3 and 4, the web conferencing application 112 can determine to locate the annotation 160 text “Why does PLS become the” in the clear space at top of cell B5 and locate the annotation 160 text “absolute estimate coefficient?” in clear space at the top of cell C5. The web conferencing application 112 can store a corresponding recommendation 332 in column 320 of the data table 300 in a manner that associates the recommendation with the annotation 160. Further, the web conferencing application 112 can re-locate the annotation 160 to the clear space in cells B5, C5 accordingly. Thus, it will be clear to the participants 130-136 viewing the presentation 150 that the annotation 160 pertains to the parent content 210. This can help the participants 130-136 in understanding the content presented in the presentation 150 and the annotation 160.

In some instances, there may be a plurality of annotations, including the annotation 160, that each pertain to the same parent content 210. In such case, the annotation 160 assigned the highest relevance parameter 180 can be located in the virtual white board 200 as previously described. For a second annotation having the next highest relevance parameter, the web conferencing application 112 can determine another location not reserved for the annotation 160 that is proximate to the parent content 210, for example cell B1, which is proximate to cell B2 containing a portion of the parent content 210. For a third annotation having the next highest relevance parameter, the web conferencing application 112 can determine another location not reserved for the annotation 160 that is proximate to the parent content 210, for example cell B6, which is proximate to cell B5 containing a portion of the parent content 210. Alternatively, the web conferencing application 112 can select cell C1 for the third annotation. The process can continue for any number of annotations that pertain to the parent content 210.

The web conferencing application 112 also can re-locate the annotation 162. Continuing with the present example, since clear space in cells B5, C5 have been reserved for the annotation 160, the web conferencing application 112 can identify one or more other cells having clear space where the annotation 162 may be moved. In this example, the relevance parameter 182 assigned to the annotation 162 does not exceed the threshold value. Accordingly, the web conferencing application 112 can determine that the annotation 162 need not be located as close as practical to the parent content 220, but may be located in unreserved clear space otherwise proximate to the parent content 220. The web conferencing application 112 can identify that cell A1 has clear space, is located proximate to the parent content 220, and is unreserved for another annotation. Thus, the web conferencing application 112 can determine to move the annotation 162 to cell A1. The web conferencing application 112 can store a corresponding recommendation 332 in column 320 of the data table 300 in a manner that associates the recommendation with the annotation 162. Further, the web conferencing application 112 can re-locate the annotation 162 to the clear space in cell A1. Accordingly, it will be clear to the participants 130-136 viewing the presentation 150 that the annotation 162 pertains to the parent content 220.

The web conferencing application 112 can store the data table 300 to a computer-readable storage medium in a manner that associates the data table 300 with the presentation 150. For example, the web conferencing application 112 can identify the presentation 150 in the data table 300, store metadata with the data table 300 identifying the presentation 150, or associate the data table 300 with the presentation 150 in another suitable manner. In one arrangement, the data table 300 can include a column (not shown) that indicates the slide of the presentation 150 with which the annotations 160, 162 are associated.

At some later point in time the presentation 150 may be presented to one or more of the same participants 130-136 and/or to other users. In response to the presentation 150 being presented, the web conferencing application 112 can access the data table 300 and process the data stored in the data table 300 to present the annotations 160, 162 in the clear space of the cells indicated in the recommendations 330, 332. Accordingly, the same annotations 160, 162 can again be presented with the presentation 150 and can be presented in the previously determined locations. Thus, annotations 160, 162 can again be used to help the participants and other users in understanding the content presented in the presentation 150 and the annotation 160.

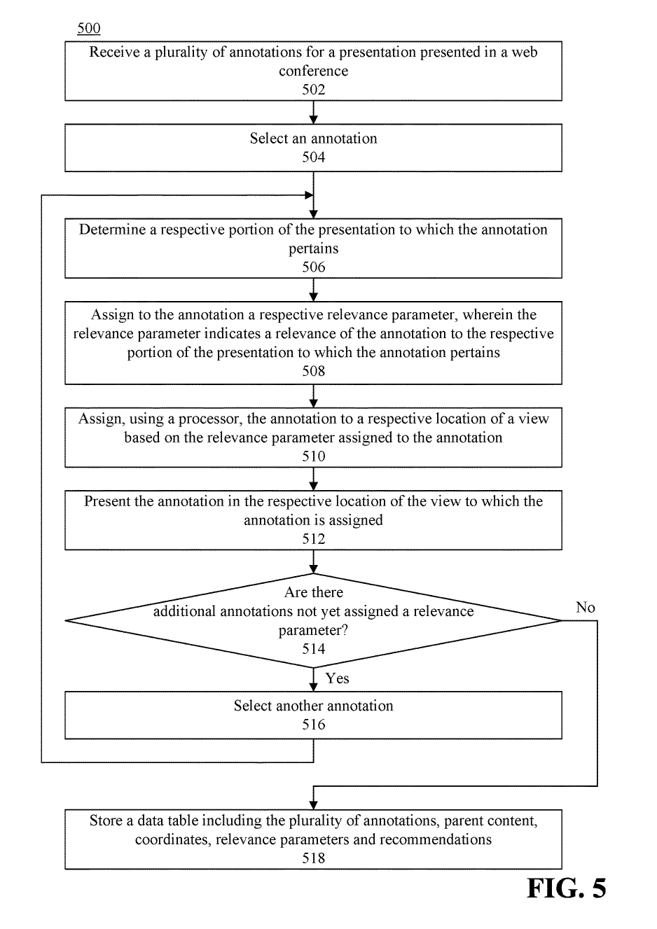

FIG. 5 is a flow chart illustrating an example of a method 500 of presenting a plurality of annotations in respective locations of a view to which the annotations are assigned. At step 502, a web conferencing application can receive a plurality of annotations for a presentation presented in a web conference. At step 504, web conferencing application can select one of the plurality of annotations. At step 506, the web conferencing application can determine a respective portion of the presentation to which the annotation pertains (i.e., parent content). At step 508, the web conferencing application can assign to the annotation a respective relevance parameter, wherein the relevance parameter indicates a relevance of the annotation to the respective portion of the presentation to which the annotation pertains. At step 510, the web conferencing application can assign, using a processor, the annotation to a respective location of a view (e.g., a virtual white board) based on the relevance parameter assigned to the annotation. At step 512, the web conferencing application can present the annotation in the respective location of the view to which the annotation is assigned. For example, the web conferencing application can

Referring to decision block 514, if there are additional annotations not yet assigned a relevance parameter, the process can proceed to step 516. At step 516, the web conferencing application can select another annotation. The process then can return to step 506 and proceed as previously described for the selected annotation. Again referring to decision block 514, if there are no additional annotations not yet assigned a relevance parameter, the process can proceed to step 518. At step 518, the web conferencing application can store a table including the plurality of annotations, the respective parent content, coordinates of the parent content and the original annotation locations, the assigned relevance parameters, and the recommendations for moving the annotations to new locations on the view. An example of such data table is depicted in FIG. 3.

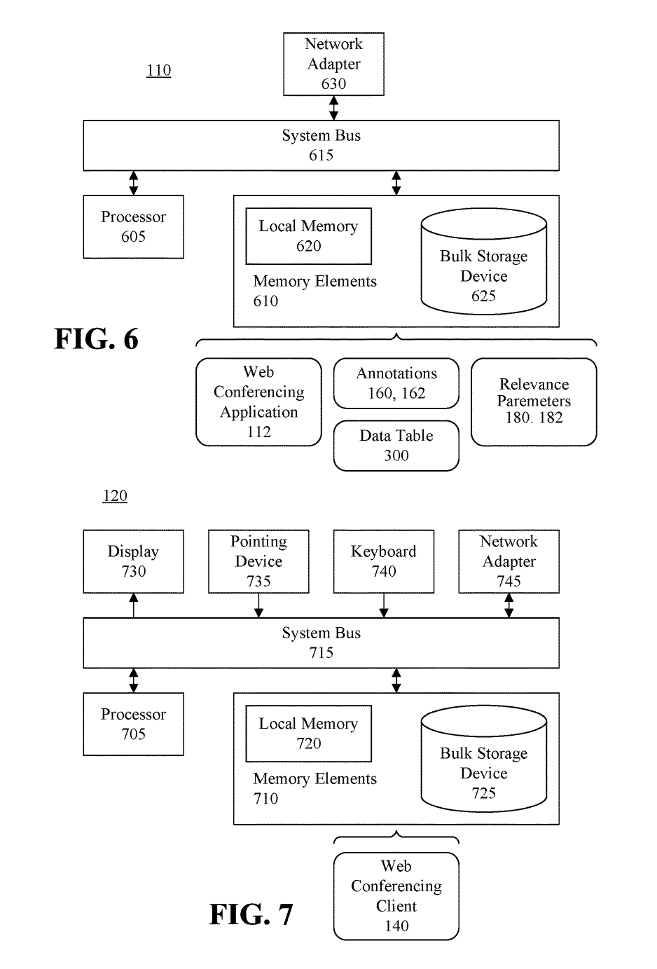

FIG. 6 is a block diagram illustrating example architecture for the server 110. The server 110 can include at least one processor 605 (e.g., a central processing unit) coupled to memory elements 610 through a system bus 615 or other suitable circuitry. As such, the server 110 can store program code within the memory elements 610. The processor 605 can execute the program code accessed from the memory elements 610 via the system bus 615. It should be appreciated that the server 110 can be implemented in the form of any system including a processor and memory that is capable of performing the functions and/or operations described within this specification. For example, the server 110 can be implemented as a single processing system or a plurality of communicatively linked processing systems.

The memory elements 610 can include one or more physical memory devices such as, for example, local memory 620 and one or more bulk storage devices 625. Local memory 620 refers to random access memory (RAM) or other non-persistent memory device(s) generally used during actual execution of the program code. The bulk storage device(s) 625 can be implemented as a hard disk drive (HDD), solid state drive (SSD), or other persistent data storage device. The server 110 also can include one or more cache memories (not shown) that provide temporary storage of at least some program code in order to reduce the number of times program code must be retrieved from the bulk storage device 625 during execution.

One or more network adapters 630 also can be coupled to server 110 to enable the server 110 to become coupled to other devices, systems, computer systems, remote printers, and/or remote storage devices through intervening private or public networks. Modems, cable modems, transceivers, and Ethernet cards are examples of different types of network adapters 630 that can be used with the server 110.

As pictured in FIG. 6, the memory elements 610 can store the web conferencing application 112 of FIG. 1. Being implemented in the form of executable program code, the web conferencing application 112 can be executed by the server 110 and, as such, can be considered part of the server 110. The memory elements 610 also can store the annotations 160, 162 and the relevance parameters 180, 182 of FIG. 1, as well as the data table 300 of FIG. 3. The web conferencing application 112, annotations 160, 162, relevance parameters 180, 182 and data table 300 are functional data structures that impart functionality when employed as part of the server 110.

FIG. 7 is a block diagram illustrating example architecture for the client device 120. The client devices 122-126 can be configured in a similar manner.

The client device 120 can include at least one processor 705 (e.g., a central processing unit) coupled to memory elements 710 through a system bus 715 or other suitable circuitry. As such, the client device 120 can store program code within the memory elements 710. The processor 705 can execute the program code accessed from the memory elements 710 via the system bus 715. It should be appreciated that the client device 120 can be implemented in the form of any system including a processor and memory that is capable of performing the functions and/or operations described within this specification.

The memory elements 710 can include one or more physical memory devices such as, for example, local memory 720 and one or more bulk storage devices 725. The client device 120 also can include one or more cache memories (not shown) that provide temporary storage of at least some program code in order to reduce the number of times program code must be retrieved from the bulk storage device 725 during execution.

Input/output (I/O) devices such as a display 730, and, optionally, a pointing device 735 and/or keyboard 740 can be coupled to the client device 120. The I/O devices can be coupled to the client device 120 either directly or through intervening I/O controllers. For example, the display 730 can be coupled to the client device 120 via a graphics processing unit (GPU), which may be a component of the processor 705 or a discrete device. One or more network adapters 745 also can be coupled to client device 120 to enable the client device 120 to become coupled to other systems, computer systems, remote printers, and/or remote storage devices through intervening private or public networks. Modems, cable modems, transceivers, and Ethernet cards are examples of different types of network adapters 745 that can be used with the client device 120.

As pictured in FIG. 7, the memory elements 710 can store the web conferencing client 140. Being implemented in the form of executable program code, the web conferencing client 140 can be executed by the client device 120 and, as such, can be considered part of the client device 120. Moreover, the web conferencing client 140 is functional data structure that imparts functionality when employed as part of the client device 120.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-7. (canceled)

8. A system, comprising:
a processor programmed to initiate executable operations comprising:
receiving a plurality of annotations for a presentation presented in a web conference; and
for each of the plurality of annotations:
determining a respective portion of the presentation to which the annotation pertains;
assigning to the annotation a respective relevance parameter, wherein the relevance parameter indicates a relevance of the annotation to the respective portion of the presentation to which the annotation pertains;
assigning the annotation to a respective location of a view based on the relevance parameter assigned to the annotation; and
presenting the annotation in the respective location of the view to which the annotation is assigned.

9. The system of claim 8, wherein determining the respective portion of the presentation to which the annotation pertains comprises:
performing natural language processing on the annotation and content of the presentation.

10. The system of claim 8, the executable operations further comprising:
determining the relevance parameter by determining a level of correlation between the annotation and the respective portion of the presentation to which the annotation pertains, determining the level of correlation comprising applying regression analysis at least on results of natural language processing performed on the annotation and content of the presentation.

11. The system of claim 8, wherein the respective location of the view to which the annotation is assigned is different than a location of the view where the annotation originally was provided.

12. The system of claim 8, the executable operations further comprising:
determining whether the relevance parameter exceeds a threshold value;
wherein assigning the annotation to the respective location of the view based on the relevance parameter assigned to the annotation is based, at least in part, on the relevance parameter exceeding the threshold value.

13. The system of claim 8, the executable operations further comprising:
wherein the respective location of the view to which the annotation is assigned is where clear space in the presentation is identified.

14. The system of claim 8, the executable operations further comprising”
responsive to assigning the annotation to a respective location of a view, reserving that location exclusively for the annotation.

15. A computer program product comprising a computer readable storage medium having program code stored thereon, the program code executable by a processor to perform a method comprising:
receiving, by the processor, a plurality of annotations for a presentation presented in a web conference; and
for each of the plurality of annotations:
determining, by the processor, a respective portion of the presentation to which the annotation pertains;
assigning, by the processor, to the annotation a respective relevance parameter, wherein the relevance parameter indicates a relevance of the annotation to the respective portion of the presentation to which the annotation pertains;
assigning, by the processor, the annotation to a respective location of a view based on the relevance parameter assigned to the annotation; and
presenting, by the processor, the annotation in the respective location of the view to which the annotation is assigned.

16. The computer program product of claim 15, wherein determining the respective portion of the presentation to which the annotation pertains comprises:
performing natural language processing on the annotation and content of the presentation.

17. The computer program product of claim 15, the method further comprising:
determining the relevance parameter by determining a level of correlation between the annotation and the respective portion of the presentation to which the annotation pertains, determining the level of correlation comprising applying regression analysis at least on results of natural language processing performed on the annotation and content of the presentation.

18. The computer program product of claim 15, wherein the respective location of the view to which the annotation is assigned is different than a location of the view where the annotation originally was provided.

19. The computer program product of claim 15, the method further comprising:
determining whether the relevance parameter exceeds a threshold value;
wherein assigning the annotation to the respective location of the view based on the relevance parameter assigned to the annotation is based, at least in part, on the relevance parameter exceeding the threshold value.

20. The computer program product of claim 15, the method further comprising:
wherein the respective location of the view to which the annotation is assigned is where clear space in the presentation is identified.

21. The computer program product of claim 15, the method further comprising:
responsive to assigning the annotation to a respective location of a view, reserving that location exclusively for the annotation.
